(19) United States
(12) Patent Application Publication
(10) Pub. No.: US 2016/0142133 A1
(43) Pub. Date: May 19, 2016

(54) Methods, Systems and Devices for Optical-Signal-to-Noise-Ratio Monitoring

(71) Applicant: University of Southern California, Los Angeles, CA (US)

(72) Inventors: Mohammad Reza Chitgarha, Los Angeles, CA (US); Salman Khaleghi, Los Angeles, CA (US); Ahmed Almaiman, Los Angeles, CA (US); Alan E. Willner, Los Angeles, CA (US)

(73) Assignee: University of Southern California, Los Angeles, CA (US)

(21) Appl. No.: 14/221,124

(22) Filed: Mar. 20, 2014

Related U.S. Application Data
(60) Provisional application No. 61/803,728, filed on Mar. 20, 2013.

(51) Int. Cl. H04B 10/079; H04J 14/02

(52) U.S. Cl. CPC H04B 10/07953; H04J 14/0227

(57) ABSTRACT

A device for optical-signal-to-noise (OSNR) monitoring can include: a delay-line interferometer configured to connect with a tunable optical filter; and two or more power detectors to measure outputs of the interferometer; wherein one or more parameters are optimized for different transmission baud rates to improve accuracy. In addition, a method can include: connecting an input of a delay-line interferometer with an output of a tunable optical filter, and an output of the delay-line interferometer with an input of a power detector, to form an optical-signal-to-noise (OSNR) monitoring apparatus; optimizing one or more parameters of the OSNR monitoring apparatus for different transmission baud rates to improve accuracy.

### CROSS REFERENCE TO RELATED APPLICATIONS

This application claims the benefit of priority from U.S. Provisional Application entitled “Methods, systems and devices for optical-signal-to-noise-ratio monitoring”, filed Mar. 20, 2013, Application Ser. No. 61/803,728, the disclosure of which is incorporated by reference in its entirety.

### STATEMENT AS TO FEDERALLY SPONSORED RESEARCH

This invention was made with government support under National Science Foundation (NSF) Center for Interacted Access Networks (CIAN) grant number 0812072. The government has certain rights in the invention.

### BACKGROUND

This specification relates to optical performance monitoring, which has gained much interest for helping maintain proper system operation in optical communication networks.

One of the most basic parameters to measure at various points around a network is the optical signal-to-noise ratio (OSNR), and there have been several approaches that have been reported. In addition to the main point that the monitor should specifically measure the signal and in-channel-band noise, there are several desirable features for an OSNR monitor that include the following points. First, the monitor should be potentially cost effective (i.e., integratable with minimal complexity) so that it can be deployed ubiquitously around the network to help diagnose and locate problems. Importantly, although coherent receivers can recover the OSNR, such receivers tend to be costly and the OSNR information may be needed at many different locations not specifically at the coherent receiver itself. Second, the monitor should accommodate different types of data modulation formats and bit rates with a minimal amount of in-situ monitor tuning; these modulation formats should probably include various forms related to polarization multiplexing as well as higher-order formats such as quadrature-phase-shift-keying (QPSK) and quadrature amplitude modulation (QAM). Third, the monitors should be useful for deployment by having well-defined operating design parameters and reasonable accuracy.

One type of OSNR monitor that holds promise for achieving many of the desired characteristics is the Mach-Zehnder-based delay-line interferometer (DLI). The DLI-based OSNR monitor measures the optical power of the constructive and destructive output ports using simple low-speed photodiodes in order to determine the signal and noise powers. The signal is coherent and experiences constructive and destructive interference in the DLI, whereas the in-band noise is typically noncoherent and experiences simple power splitting from the DLI. Previous results using this type of monitor include single-WDM (Wave-Division Multiplexing)-channel 40-Gbit/s BPSK (Binary Phase-Shift Keying) data in a non-pol-muxed system. Laudable goals for the ultimate usability of this DLI monitor would be demonstrating its viability to measure high-bit-rate pol-muxed QPSK and QAM data in a WDM system, as well as determining important design guidelines and level of accuracy for practical deployment.

### SUMMARY

This specification relates to optical performance monitoring, as can be applied in fiber optic links and subsystems, networks, and network survivability. This specification shows a demonstration of an optical-signal-to-noise-ratio (OSNR) monitoring scheme of 200-Gbit/s PM-16QAM and 100-Gbit/s QPSK signals using Mach-Zehnder delay-line-interferometer with <0.5 dB error for signals with up to 22 dB actual OSNR. Also shown is the usability of this scheme by varying different parameters, and design guidelines are determined to achieve a desired level of accuracy.

In this specification, design guidelines are provided, and an OSNR performance monitor for 200 Gbit/s pol-muxed 16-QAM and 100 Gbit/s pol-muxed QPSK in both single and WDM data channels is demonstrated. Our OSNR monitoring scheme is capable of achieving <0.5 dB error for signals with <22 dB actual OSNR. Different parameters are also examined to determine the design guidelines for a desired level of OSNR monitor accuracy in a network. The performance is assessed by measuring the OSNR error at wide range of delay, phase and filter parameters.

In general, an aspect of the subject matter described in this specification can be embodied in a device for optical-signal-to-noise (OSNR) monitoring includes: a delay-line interferometer configured to connect with a tunable optical filter; and two or more power detectors to measure outputs of the interferometer; wherein one or more parameters are optimized for different transmission baud rates to improve accuracy. Other embodiments of this aspect include corresponding systems and apparatus.

These and other embodiments can optionally include one or more of the following features. A delay value of the delay-line interferometer can be optimized based on phase fluctuations, a monitored channel, and a center frequency for the monitored channel. A voltage of the delay-line interferometer can be tuned so that a power difference between constructive and destructive ports is maximized. Moreover, filter bandwidth and filter shape can be optimized.

The device can be capable of achieving <0.5 dB error for signals with <22 dB actual OSNR. The device can be configured to measure OSNR on high-bit-rate pol-muxed QPSK and QAM data in WDM channels. In addition, the device can be configured to measure OSNR based on (i) measured power at a constructive port, (ii) measured power at a destructive port, (iii) a ratio between the measured power at the constructive port and the measured power at the destructive port, and (iv) a noise distribution ratio for a case when only ASE (Amplified Spontaneous Emission) noise is transmitted.

According to another aspect of the subject matter described in this specification, a method includes: connecting an input of a delay-line interferometer with an output of a tunable optical filter, and an output of the delay-line interferometer with an input of a power detector, to form an optical-signal-to-noise (OSNR) monitoring apparatus; optimizing one or more parameters of the OSNR monitoring apparatus for different transmission baud rates to improve accuracy.

These and other embodiments can optionally include one or more of the following features. The optimizing can include optimizing a delay value of the delay-line interferometer based on phase fluctuations, a monitored channel, and a center frequency for the monitored channel. The optimizing can include tuning a voltage of the delay-line interferometer so that a power difference between constructive and destructive ports is maximized. The optimizing can also include optimizing filter bandwidth and filter shape. Moreover, the method can include measuring OSNR based on (i) measured power at a constructive port, (ii) measured power at a destructive port, (iii) a ratio between the measured power at the constructive port and the measured power at the destructive port, and (iv) a noise distribution ratio for a case when only ASE (Amplified Spontaneous Emission) noise is transmitted.

### BRIEF DESCRIPTION OF THE DRAWINGS

FIG. 1A shows an OSNR monitor for WDM channels using a delay-line-interferometer.

FIG. 1B shows a block diagram of an OSNR monitor.

FIGS. 2A and 2B show an experimental setup for simultaneous OSNR monitoring of polarization multiplexed signals.

FIG. 3 shows simulated measurement error vs. DLI delay for low (5 dB), medium (15 dB) and high (20 dB) OSNR, 100-Gbit/s PM-QPSK.

FIG. 4 shows measurement error vs. DLI phase, simulation and experiment results for low (5 dB), medium (15 dB) and high (20 dB) OSNR, 100-Gbit/s PM-QPSK.

FIG. 5 shows figure of merit (combination of phaseinstability and measurement error) vs. DLI delay, simulation and experiment results for low, medium and high OSNR, 100-Gbit/s PM-QPSK.

FIG. 6 shows measured vs. actual OSNR for four 25-Gbaud PM-QPSK WDM channels and average error.

FIG. 7 shows measurement error vs. actual OSNR for different modulation formats at same baud rate of 25-Gbaud.

FIG. 8 shows measurement error vs. actual OSNR for different baud rates and same modulation format PM-QPSK.

FIG. 9 shows a block diagram of an Mach-Zehnder interferometer (MZI) based one-time calibrated OSNR monitor for reconfigurable networks.

FIG. 10 shows an experimental setup for an OSNR monitor under changing transmitter and noise in reconfigurable networking conditions.

FIG. 11 shows experimential results of EVM [%] vs. MZM₁ bias drifting.

FIG. 12 shows OSNR error [dB] with respect to EVM for the MZM₁ drifting experiment.

FIG. 13 shows experimental OSNR error [dB] for random scenarious of drifting in both I and Q biases.

FIG. 14 shows EVM [%] vs. experimental voltage drifting introduced on the phase modulator.

FIG. 15 shows experimental resulted error [dB] due to the phase modulator drift.

FIG. 16 shows experimental OSNR error [dB] due to changing baud rate while using a 25 Gbaud signal calibration α_{Ref}.

FIG. 17 shows experimentally measured α calibration factor value with respect to baud rate for different modulation formats.

FIG. 18 shows error [dB] for PM-BPSK and PM-16-QAM at different baud rates when a PM-QPSK calibration factor is measured at each specific baud rate and applied to PM-BPSK and PM-16-QAM.

FIG. 19 shows experimental error [dB] for applying certain a calibration on different wavelengths.

FIG. 20 shows profiles of recorded ASE power [dBm] after paths Aₙₒᵢₛₑ and Bₙₒᵢₛₑ.

FIG. 21 shows measured error [dB] for re-routed PM-QPSK and PM-16-QAM signals using α_{Ref} and β_{Ref}.

Like reference characters in the various drawings indicate like elements.

### DETAILED DESCRIPTION

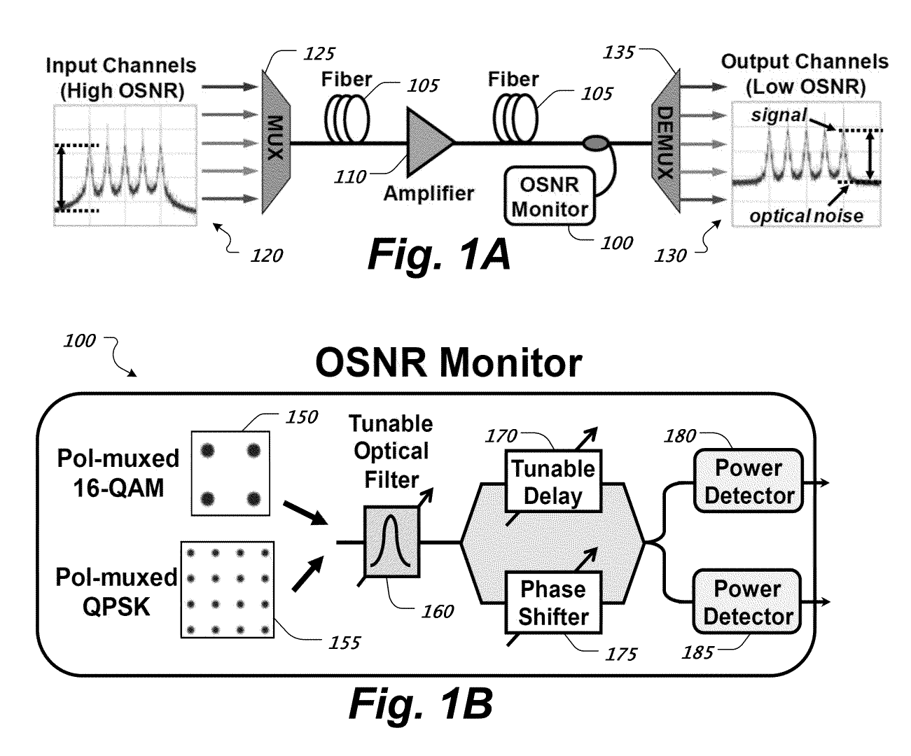

FIG. 1A shows an OSNR monitor 100 for WDM channels 120, 130 using a delay-line-interferometer. Input channels 120 provide high OSNR signals spanning a range of wavelengths. The input signals are mulitplexed at MUX 125 and routed through fiber 105. An amplifier 110 boosts the signals within the fiber 105, and the OSNR monitor 100 keeps tabs on the signals before they are demultiplexed at DEMUX 135 and sent over output channels 130 with low OSNR.

FIG. 1B shows a block diagram of the OSNR monitor 100. The monitor 100 consists of a tunable optical filter 160 to extract a desired channel from a WDM system (e.g., pol-muxed 16-QAM 150 and pol-muxed QPSK 155) and a DLI (e.g., a tunable delay 170 and a phase shifter 175) followed by two power detectors 180, 185 to measure DLI output powers. This optical filter along with all cascaded filters in the optical link can be seen as an effective bandpass filter (BPF) centered at λ₀ and with bandwidth of Δf. The DLI with a delay T on one of its arms is indeed a finite impulse response filter with FSR (frequency spacing between two successive maximas or minimas of an interferometer spectrum) of 1/T and is polarization insensitive. When only signal is sent through the monitor (i.e., OSNR is very high), the ratio between the powers of the constructive and the destructive ports can be defines as α. Similarly, β can be defined as the noise distribution ratio for the case when only ASE (Amplified Spontaneous Emission) noise is transmitted.

Because optical filters are linear systems, the net power distribution between DLI ports is the summation of power distribution of signal and noise between DLI output ports individually. According to the superposition property,

$${P}_{Dest} = \frac{1}{α + 1} {P}_{Sig} + \frac{1}{β + 1} {P}_{N} and {P}_{Const} = \frac{α}{α + 1} {P}_{Sig} + \frac{β}{β + 1} {P}_{N} ,$$

in which P_{Const}, P_{Dest}, P_{Sig} and P_{N} are the measured power at the constructive port, measured power at the destructive port, actual signal power and actual noise power, respectively. Thus, by solving this system of linear equations, one can obtain the OSNR from the measured DLI powers

$$OSNR = \frac{{P}_{Sig}}{{P}_{N}} + \frac{( α + 1 ) ( {P}_{Const} - β {P}_{Dest} )}{( β + 1 ) ( α {P}_{Dest} - {P}_{Const} )} .$$

The error of this calculated OSNR, therefore, depends on the measurement accuracy of P_{Const}, P_{Dest}, α and β . Both α and β depend on the frequency response of effective BPF as well as the FSR of the DLI. This measurement accuracy is determined by the resolution of power meters, stability of the DLI's parameters (i.e., phase and delay) and stability of the effective BPF frequency response (i.e., center frequency, bandwidth, and shape).

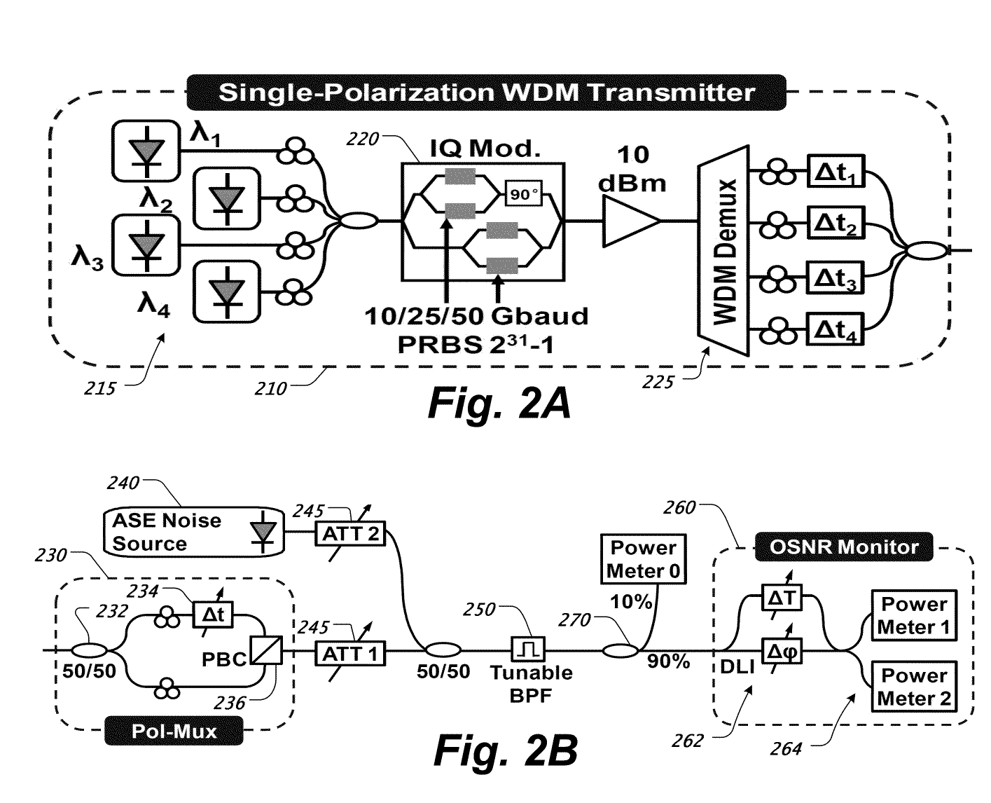

FIGS. 2A and 2B show an experimental setup for simultaneous OSNR monitoring of polarization multiplexed signals. As depicted, a 4-channel WDM system includes single-polarization WDM transmitter 210 providing an input to pol-mux 230, which connects with OSNR monitor 260. The single-polarization WDM transmitter 210 in this example includes four lasers 215 (λ₁, λ₂, λ₃, λ₄) (e.g., 50-GHz ITU grid, around 1550 nm) sent into an IQ modulator 220 that is driven by 2³¹−1 pseudo-random bit sequence (PRBS) data at variable baud rates (e.g., 10/25/50 GHz).

After WDM Demux 225 and any appropriate delays (Δt₁, Δt₂, Δt₃, Δt₄), the single-polarization signal is then split to half at 232, delayed at 234 and combined in a polarization beam combiner (PBC) 236 to emulate pol-mux. An ASE broadband noise source 240 is coupled with the signal(s). Attenuators (ATT) 245 are used on the signals and the noise path to vary OSNR. A WDM channel is then selected using a tunable Gaussian BPF 250 and sent to the OSNR monitor 260 (e.g., a tunable DLI 262 and power meters 264). The 10% tap 270 is used after the filter to measure actual signal and noise powers (i.e., actual OSNR).

The proposed OSNR monitor has four design parameters: (a) the delay of DLI (ΔT), (b) maximum DLI phase detuning (Δφ), (c) filter bandwidth (Δf) and (d) filter center frequency. In order to realize accurate OSNR monitoring in an optical network, the following design rules and guidelines should be considered for any optical network. First, for monitoring a specific channel, the center frequency of the BPF filter should be tuned to the center of that channel. The filter bandwidth should not be significantly wider than the effective bandwidth of each channel to minimize the negative effects of the leaked neighboring channels in the WDM systems. A very narrowband filter, on the other hand, can change the actual OSNR of the signal and increases the error.

Second, the trade-off in choosing the DLI delay value lies in the fact that smaller delays can often increase the accuracy of the OSNR monitor but they are more sensitive to the DLI phase fluctuations. Since multiple 50-GHz-spaced WDM channels are monitored at 25 Gbaud in this example, the bandwidth of the filter is 0.3 nm (equivalent to at least three consecutive filters with 50 GHz bandwidth). Two types of filter (Gaussian and Lorentzian) are studied.

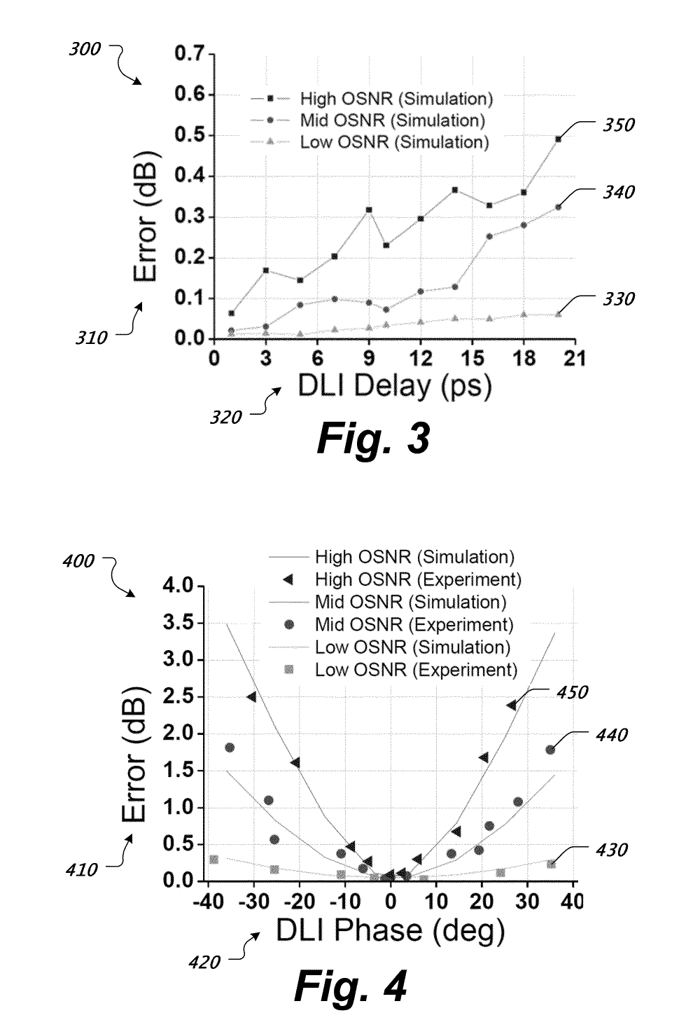

FIG. 3 shows a graph 300 with simulated measurement error 310 vs. DLI delay 320 for low (5 dB) 330, medium (15 dB) 340 and high (20 dB) 350 OSNR, 100-Gbit/s PM-QPSK. In FIG. 3, the accuracy of the proposed scheme for OSNR monitoring is assessed for DLIs with different delays for three levels of OSNR: low (5 dB) 330, medium (15 dB) 340 and high (20 dB) 350, and a Lorentzian filter shape. As simulations show, the error level increases for higher delays. It is worth mentioning that in each experimental measurement, in order to minimize the DLI phase drifting effect, the DLI voltage is tuned so that the power ratio between constructive and destructive ports is optimized (i.e., a power difference between constructive and destructive ports is maximized).

FIG. 4 shows a graph 400 with measurement error 410 vs. DLI phase 420, simulation and experiment results for low (5 dB) 430, medium (15 dB) 440 and high (20 dB) 450 OSNR, 100-Gbit/s PM-QPSK. In FIG. 4, the actual OSNR and the filter bandwidth are fixed at 20 dB and 0.3 nm, respectively, and the OSNR measurement error is calculated based on both simulations and experiment for different DLI phases.

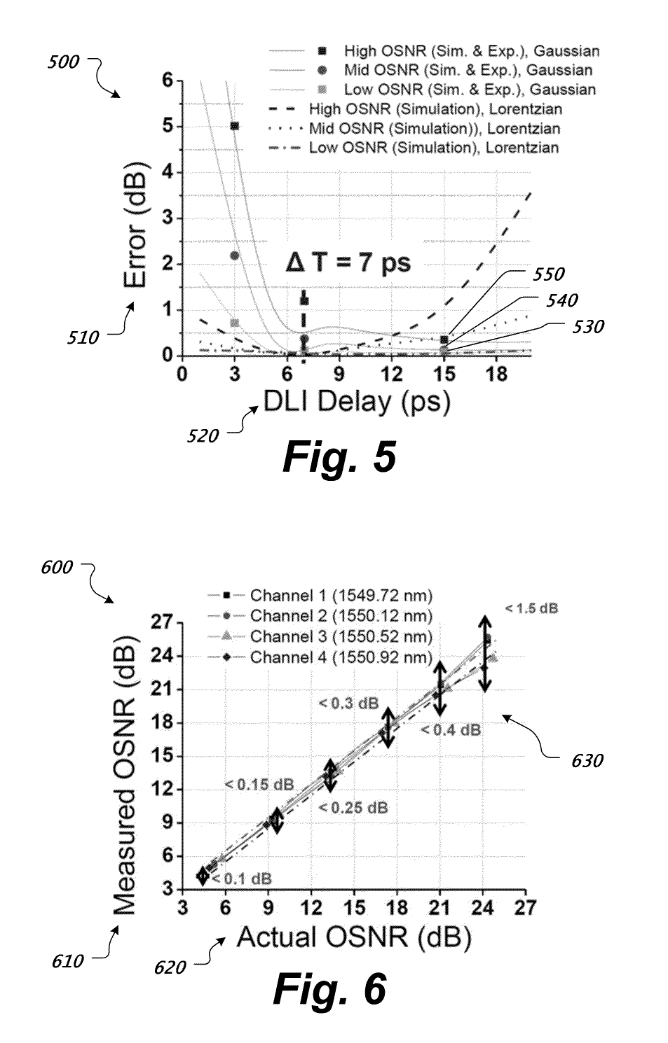

FIG. 5 shows a graph 500 with figure of merit (combination of phaseinstability and measurement error) 510 vs. DLI delay 520, simulation and experiment results for low 530, medium 540 and high 550 OSNR, 100-Gbit/s PM-QPSK. In FIG. 5, an error margin of 18 degrees for DLI phase drifting is assumed and the total OSNR measurement error is depicted for different DLI delay values. The Lorentzian filter resulted in the minimum error in the single-channel simulation, whereas a Gaussian filter had better performance for the WDM system. The difference in the OSNR performance was likely due to the difference in roll-off factors in these three filters. Although the low roll-off factor in the Lorentzian filter decreased the error in the OSNR measurement in the single-channel simulation by increasing the difference between the signal and the noise coherence, it maximized the negative effects of the leaked neighboring channels in the WDM system.

The phase fluctuation can be the result of temperature changes. We can conclude from simulations and experiments that the optimum value for DLI delay is 7 ps (17.5% of the symbol time) for 100-Gbit/s PM-QPSK signals, with either Lorentzian or Gaussian filter shapes. For this value, the OSNR monitor achieves <0.5 dB measurement accuracy. The rest of the experiments have also been performed using a 7-ps DLI. At shorter DLI delays, phase fluctuations make it difficult to record the maximum power difference between the constructive and destructive power levels. On the other hand, implementing delays longer than a bit delay leads the α and β values to be close to each other and less distinguishable and eventually lower accuracy OSNR measurement occurs.

FIG. 6 shows a graph 600 of measured OSNR 610 vs. actual OSNR 620 for four 25-Gbaud PM-QPSK WDM channels and average error. FIG. 6 depicts the accuracy 630 of OSNR measurement for four WDM channels (Channel 1 being about 1549.72 nm, Channel 2 being about 1550.12 nm, Channel 3 being about 1550.52 nm, and Channel 4 being about 1550.92 nm). For OSNR values of <22 dB, the OSNR monitor achieves <0.5 dB accuracy. It is worth noting that high accuracy in OSNR measurement is more important for lower (<20 dB) OSNR values, because the signal quality can become marginal for lower OSNRs.

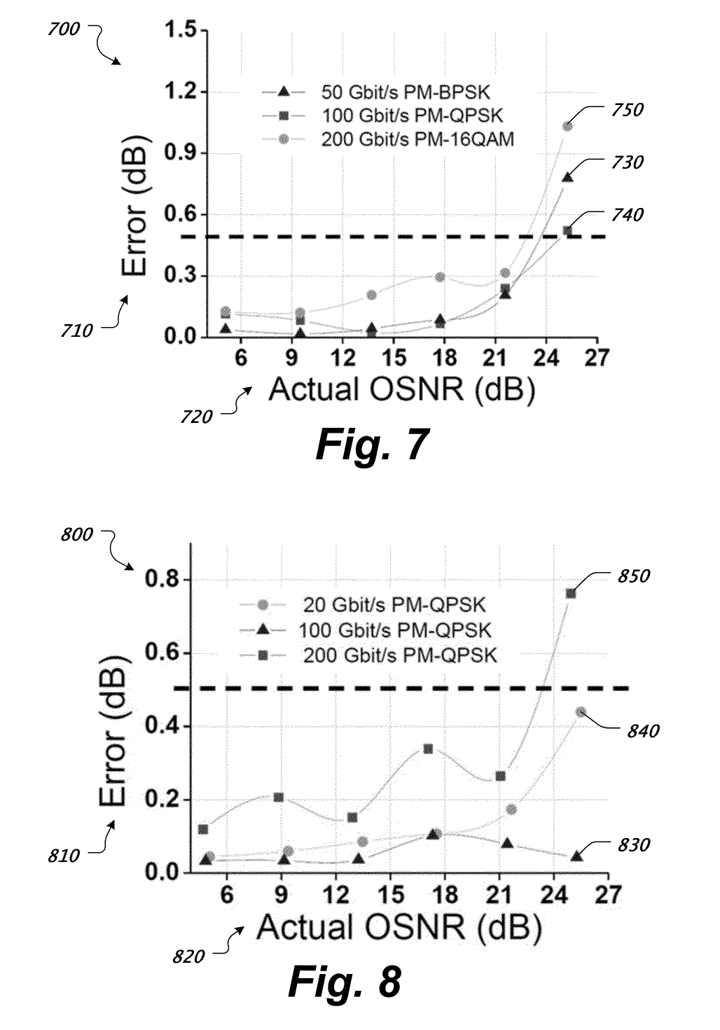

FIG. 7 shows a graph 700 of measurement error 710 vs. actual OSNR 720 for different modulation formats at same baud rate of 25-Gbaud. In FIG. 7, Channel 3 at 1550.52 nm is modulated using BPSK 730 (50 Gbit/s PM-BPSK), QPSK 740 (100 Gbit/s PM-QPSK) and 16-QAM 750 (200 Gbit/s PM-16QAM) formats at 25 Gbaud. The OSNR is measured with <0.5 dB error for OSNR values of <20 dB. Therefore, the same systems can also work for various modulation formats with the same baud rate.

FIG. 8 shows a graph 800 of measurement error 810 vs. actual OSNR 820 for different baud rates 830, 840, 850 and same modulation format PM-QPSK. FIG. 8 thus shows measurement accuracy for QPSK signal with various baud rates (10, 25, and 50-Gbaud). For each baud rate, the filter bandwidth is changed accordingly. Again, <0.5 dB measurement error is observed for various bit-rates. In summary, we studied and provided design guidelines for a simple and low-cost OSNR monitor and we experimentally demonstrated <0.5 dB measurement accuracy for WDM systems, various modulation formats and various bit rates of up to 200-Gbit/s.

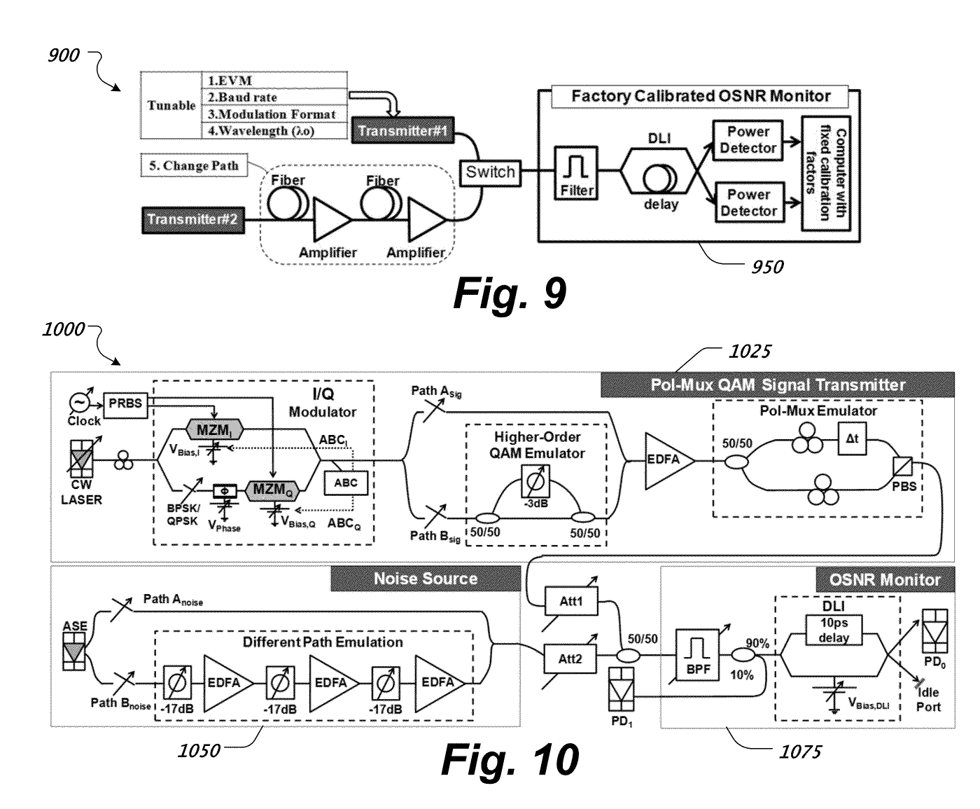

In addition, the robustness of an Mach-Zehnder interferometer (MZI) based OSNR monitor under reconfigurable network and transmitter drift can be demonstrated. FIG. 9 shows a block diagram of an MZI based one-time calibrated OSNR monitor 950 for reconfigurable networks 900. In this example, the monitor calibration factors for 25 Gbaud PM-QPSK signal can be stored after assembly and can be applied to study the accuracy of the OSNR monitoring unit when different changing scenarios outside the monitor occur.

The ability of optical performance monitoring to help determine the relative health of various optical data channels can enable: (i) the identification and location of data-degrading effects at different points in the system, and (ii) routing traffic based on the relative “quality” of a given physical route. Such monitoring should optimally be located at many points of the system. The OSNR can be a crucial metric of the health of a data channel at various points around a network, and the value of an MZI-based OSNR monitor can be demonstrated, with various issues addressed, such as (i) OSNR calibration after assembly (so that it accurately measures signal and noise), (ii) performance when transmitter parameters drift or the data channel is modified, (iii) performance when the data channel originates from a different source transmitter due to reconfigurable networking or transmitter replacement, (iv) performance when the baud rate or modulation format of the data channel is changed, and (v) OSNR monitor function under changing network conditions with required servicing, updating or recalibration.

As shown in FIG. 9, the monitor 950 (Factor Calibrated OSNR Monitor, including BPF, DLI with delay, power detectors, and computer with fixed calibration factors) is initially calibrated with its signal and noise distribution factors (α and β) once. Then the following items are changed to emulate the reconfigurable network and conduct accuracy study: (a) error vector magnitude (EVM), (b) baud rate, (c) modulation format, (d) wavelength, and (e) path. This study shows that the monitor 950 is robust and can achieve <0.5 dB error at specific baud rate for most of the cases. Thus, the robustness and accuracy of an MZI-based OSNR monitor is demonstrated under transmitter drift and reconfigurable networking conditions for pol-muxed 25-Gbaud QPSK and 16-QAM channels.

FIG. 10 shows an experimental setup 1000 for an OSNR monitor 1075 under changing transmitter (Pol-Mux QAM Signal Transmitter 1025) and noise (Noise Source 1050) in reconfigurable networking conditions. As shown in FIG. 10, a tunable-wavelength laser sends a continuous-wave (CW) light at λo and is modulated using I/O. modulator driven by a 231-1 pseudo-random bit sequence (PRBS) with a tunable clock (i.e., tunable baud rate). The modulator is adjusted to transmit an optimal QPSK signal by automatic bias control (ABC) feedback loop on the Mach-Zehnder modulators (MZMs), and by setting the phase modulator bias (VPhase) at φ=π/2. This QPSK signal can feed a higher-order QAM emulator to generate 16-QAM. The modulated signal then passes through a pol-mux emulator, which splits, delays, and combines the orthogonal polarization states using polarization controllers and a polarization beam splitter (PBS). For the noise, an ASE source can be either added directly to the channel or routed through three cascaded EDFA's (Erbium-Doped Fiber Amplifiers) to imitate the effect of changing the path. Both signal and noise are coupled to the OSNR monitor through variable attenuators Att1 and Att2 for signal and noise, respectively. The OSNR monitoring unit consists of a 0.3 nm fixed-bandwidth tunable-wavelength bandpass filter (BPF) followed by a coupler and a polarization-insensitive 10 ps fixed-delay DLI (i.e., FSR=100 GHZ).

To perform the OSNR measurement, one of the DLI output ports is connected to a low-speed photodiode PD_{D}. Because filters are linear systems, the computations of output signal and noise powers at that DLI port yield to:

$$OSNR ( dB ) {=}^{Δ} 10 {log}_{10} ( \frac{( α + 1 ) \cdot ( δ - β )}{( β + 1 ) \cdot ( α - δ )} \cdot \frac{NEB}{0.1 nm} ) ;$$

$$α = \frac{{P}_{Const , Sig}}{{P}_{Dest , Sig}} , β = \frac{{P}_{Const , Noise}}{{P}_{Dest , Noise}} , and δ = \frac{{P}_{Const , Ch}}{{P}_{Dest , Ch}} .$$

In the above equation, α, β, and δ are the signal, noise, and channel under test distribution factors, respectively. NEB is defined as the noise equivalent bandwidth for the filter. The constructive (P_{Const,Sig}, P_{Const,Noise}, P_{Const,Ch}) and destructive (P_{Dest,Sig}, P_{Dest,Noise}, P_{Dest,Ch}) power levels for signal, noise and channel are measured by sweeping the DLI phase bias (V_{Bias,DLI}) over a full cycle.

The OSNR monitor should follow a calibration procedure to measure α and β before starting the accurate OSNR measurements. Calibrating α is conducted by sending signal and blocking the noise. Similarly, the signal should be blocked to measure the noise's β. As a result, only δ remains unknown to determine the OSNR. Here, the monitor can be initially calibrated with α_{ref} for an optimally biased 25 Gbaud pol-muxed QPSK (PM-QPSK) signal, and then β_{ref} can be calibrated for ASE noise sent through path Aₙₒᵢₛₑ. Afterwards, at the transmitter, the signal's (a) EVM (b) baud rate, (d) modulation format, and (d) wavelength can be varied, and the accuracy can be tested based on the previously stored α_{ref}. The error due to applying a stored noise calibration factor β_{ref} to a different noise can also be measured. In order to compare the results, the actual OSNR in every experiment was found by sending the signal and noise separately and measuring the tap power on PD₁.

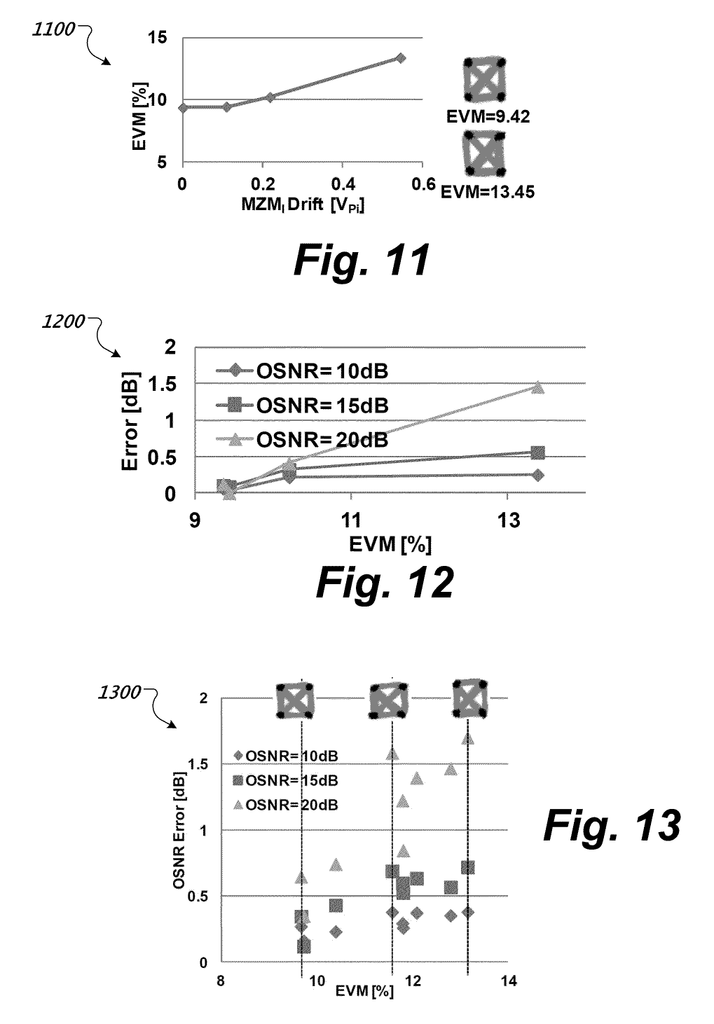

FIG. 11 shows a graph 1100 of experimential results of EVM [%] vs. MZM₁ bias drifting. ABC was switched off and V_{Bias,I} was tuned manually from an optimal point by >50% V_{Pi} to give 13.4% EVM. FIG. 11 relates the EVM degredation recorded in the transmitter using a coherent receiver and the voltage bias fluctuation on MZMᵢ. The OSNR was also measured, and it was observed that up to 10.2% EVM (i.e., 22% Vₚᵢ of drifting), the monitor showed less than 0.5 dB error. FIG. 12 shows a graph 1200 of OSNR error [dB] with respect to EVM for the MZM, drifting experiment. This suggests that for a drift on single MZM, the OSNR monitor can still perform accurately within 0.5 dB error up to 22% of Vₚᵢ drift in the bias voltage.

FIG. 13 shows a graph 1300 of experimental OSNR error [dB] for random scenarious of drifting in both I and Q biases. As shown, the OSNR error at various EVM values resulting from random independent biasing of both I/O. modulator arms with permitting <43% Vₚᵢ drift was generally below 2 and was entirely below 1 for OSNR values of 10 dB and 15 dB. In this scenario, the OSNR monitor performed with an accuracy that is dependent on the EVM performance, and the OSNR error was directly proportional to the EVM level.

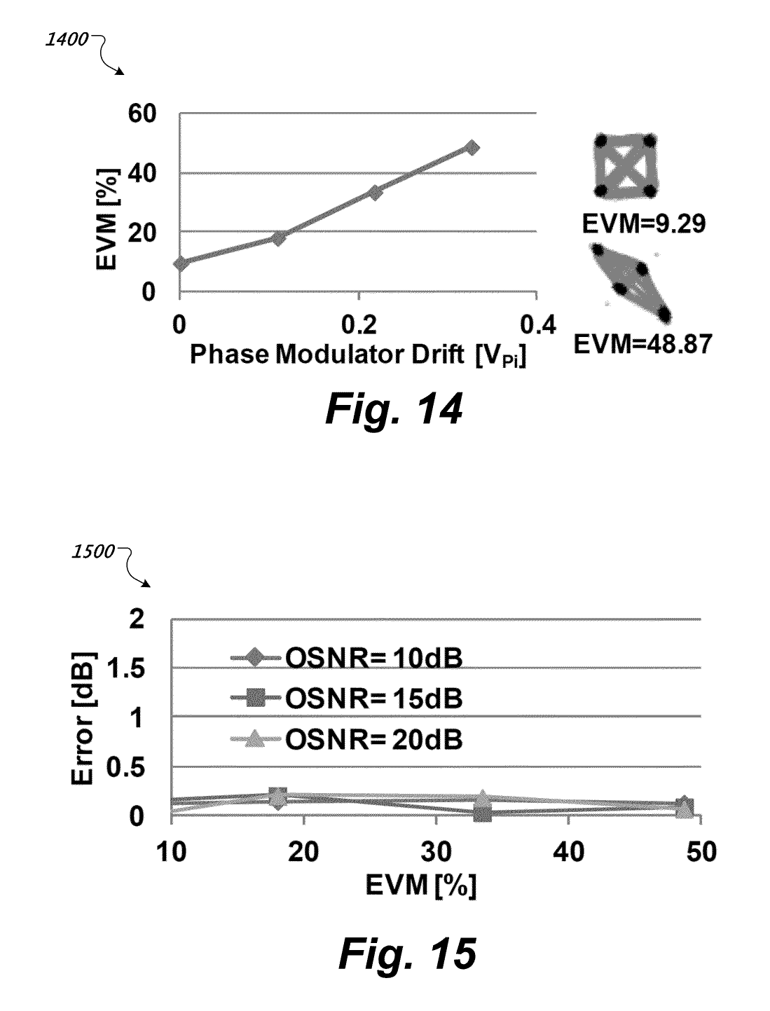

Moreover, FIG. 14 shows the measured effects of changing the phase modulator bias on the EVM while the ABC is turned on. FIG. 14 shows a graph 1400 of EVM [%] vs. experimental voltage drifting introduced on the phase modulator. FIG. 15 shows a graph 1500 of experimental resulted error [dB] due to the phase modulator drift. The error that the OSNR monitor faces due to the transmitter's phase modulator drift is shown in FIG. 15. This graph suggests that this OSNR monitor's accuracy is independence of changes in phase modulator bias although EVM is severely degraded.

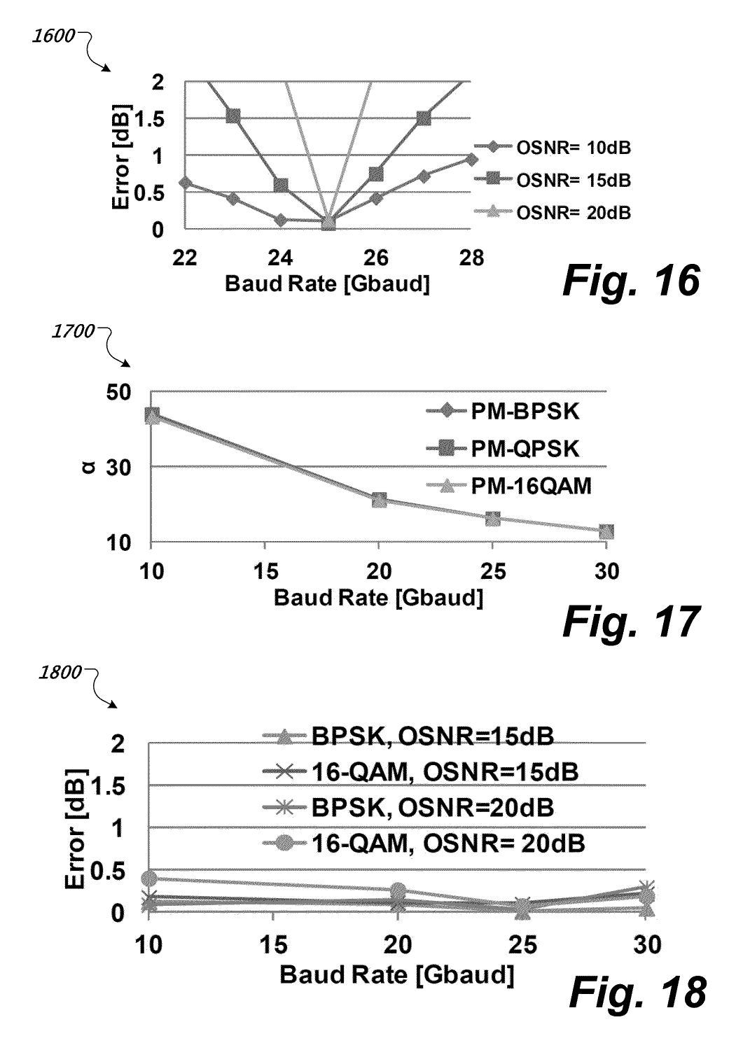

FIG. 16 shows a graph 1600 of experimental OSNR error [dB] due to changing baud rate while using a 25 Gbaud signal calibration α_{Ref}. The experimental OSNR error due to changing baud rate while using a 25 Gbaud signal calibration α_{ref} showed the monitor having high error if α_{ref} is used at other baud rates. FIG. 17 shows a graph 1700 of experimentally measured α calibration factor value with respect to baud rate for different modulation formats. The experimentally measured α calibration factor value compared with baud rate for different modulation formats indicated the distribution factor for different pol-muxed signals at different baud rates and suggests that a calibration is a baud rate specific.

However, at every specific baud rate, different modulation formats had almost the same a factor. FIG. 18 shows a graph 1800 of error [dB] for PM-BPSK and PM-16-QAM at different baud rates when a PM-QPSK calibration factor is measured at each specific baud rate and applied to PM-BPSK and PM-16-QAM. Conducting a study on accuracy under changing the modulation format was done using the PM-QPSK calibration values from the experimentally measured a calibration factor value, and these were applied to PM-BPSK and PM-16-QAM signals at those specific baud rates. Under this study, the error stayed within 0.5 dB. The OSNR monitor calibration factors for BPSK, QPSK, 16-QAM transmitter are similar and it is only necessary to calibrate the signal for one of these modulation formats. Signal calibration factor for one of theses modulation formats can be utilized on the other modulation formats with less than 0.5 dB error.

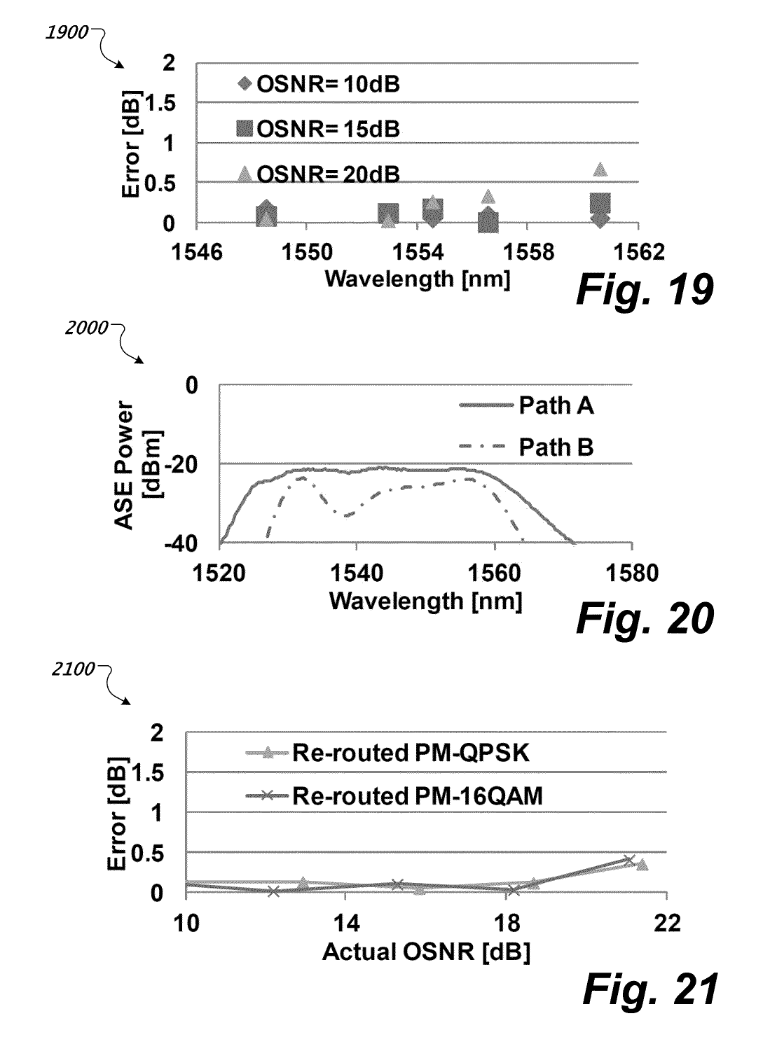

FIG. 19 shows a graph 1900 of experimental error [dB] for applying certain a calibration on different wavelengths. As shown, the effect of changing the wavelength at the transmitter was also studied, by checking the experimental error for applying certain α calibration on different wavelengths. The α calibration was taken at 1554.54 nm and applied to different ITU WDM channels. The laser wavelength was tuned, the filter re-centered, the noise's β was recalibrated, and the OSNR was measured. The maximum recorded error was 0.67-dB at 1560.61 nm (6.07 nm away from calibrated channel) in the high OSNR case. This suggests that calibration is wavelength insensitive, and that signal calibration can even be independent to the channel wavelength. Thus, signal calibration at a specific wavelength can be applied at different wavelengths with 0.5 dB OSNR measurement accuracy.

FIG. 20 shows a graph 2000 of profiles of recorded ASE power [dBm] after paths Aₙₒᵢₛₑ and Bₙₒᵢₛₑ. This further investigation of effects showed the measured error caused by applying the α_{ref} and β_{ref} to 25 Gbaud PM-QPSK and PM 16-QAM at λ=1552.52 nm changing the path (re-routing). Again, the monitor remained robust at this condition with <0.5 dB error. FIG. 20 shows the noise spectrum at the first point in the network (Path A) and after 3 amplifications (Path B). FIG. 21 shows a graph 2100 of measured error [dB] for re-routed PM-QPSK and PM-16-QAM signals using α_{Ref} and β_{Ref}. Thus, the noise distribution for a path that accumulates the ASE noise at a specific wavelength remains the same at different points of the link, and measuring the OSNR accurately is still feasible.

The systems and techniques described above, and all of the functional operations described in this specification, can be implemented in various communication networks (e.g., optical communications networks deploying network survivability elements) and with various fiber optic links and subsystems. It will be appreciated that the order of operations presented is shown only for the purpose of clarity in this description. No particular order may be required for these operations to achieve desirable results, and various operations can occur simultaneously or at least concurrently.

The various implementations described above have been presented by way of example only, and not limitation. Thus, the principles, elements and features described may be employed in varied and numerous implementations, and various modifications may be made to the described embodiments without departing from the spirit and scope of the invention. Accordingly, other embodiments may be within the scope of the following claims.

What is claimed is:

1. A device for optical-signal-to-noise (OSNR) monitoring, the device comprising:
a delay-line interferometer configured to connect with a tunable optical filter; and
two or more power detectors to measure outputs of the interferometer;
wherein one or more parameters are optimized for different transmission baud rates to improve accuracy.

2. The device of claim 1, wherein a delay value of the delay-line interferometer is optimized based on phase fluctuations, a monitored channel, and a center frequency for the monitored channel.

3. The device of claim 2, wherein a voltage of the delay-line interferometer is tuned so that a power difference between constructive and destructive ports is maximized.

4. The device of claim 3, wherein filter bandwidth and filter shape are optimized.

5. The device of claim 4, wherein the device is capable of achieving <0.5 dB error for signals with <22 dB actual OSNR.

6. The device of claim 5, configured to measure OSNR on high-bit-rate pol-muxed QPSK and QAM data in WDM channels.

7. The device of claim 6, configured to measure OSNR based on (i) measured power at a constructive port, (ii) measured power at a destructive port, (iii) a ratio between the measured power at the constructive port and the measured power at the destructive port, and (iv) a noise distribution ratio for a case when only ASE (Amplified Spontaneous Emission) noise is transmitted.

8. The device of claim 1, wherein a voltage of the delay-line interferometer is tuned so that a power difference between constructive and destructive ports is maximized.

9. The device of claim 8, wherein filter bandwidth and filter shape are optimized.

10. The device of claim 8, configured to measure OSNR based on (i) measured power at a constructive port, (ii) measured power at a destructive port, (iii) a ratio between the measured power at the constructive port and the measured power at the destructive port, and (iv) a noise distribution ratio for a case when only ASE (Amplified Spontaneous Emission) noise is transmitted.

11. The device of claim 1, wherein filter bandwidth and filter shape are optimized.

12. The device of claim 11, wherein the device is capable of achieving <0.5 dB error for signals with <22 dB actual OSNR.

13. The device of claim 11, configured to measure OSNR based on (i) measured power at a constructive port, (ii) measured power at a destructive port, (iii) a ratio between the measured power at the constructive port and the measured power at the destructive port, and (iv) a noise distribution ratio for a case when only ASE (Amplified Spontaneous Emission) noise is transmitted.

14. The device of claim 1, configured to measure OSNR on high-bit-rate pol-muxed QPSK and QAM data in WDM channels, wherein the device is capable of achieving <0.5 dB error for signals with <22 dB actual OSNR.

15. The device of claim 1, configured to measure OSNR based on (i) measured power at a constructive port, (ii) measured power at a destructive port, (iii) a ratio between the measured power at the constructive port and the measured power at the destructive port, and (iv) a noise distribution ratio for a case when only ASE (Amplified Spontaneous Emission) noise is transmitted.

16. A method comprising:
connecting an input of a delay-line interferometer with an output of a tunable optical filter, and an output of the delay-line interferometer with an input of a power detector, to form an optical-signal-to-noise (OSNR) monitoring apparatus;
optimizing one or more parameters of the OSNR monitoring apparatus for different transmission baud rates to improve accuracy.

17. The method of claim 16, wherein the optimizing comprises optimizing a delay value of the delay-line interferometer based on phase fluctuations, a monitored channel, and a center frequency for the monitored channel.

18. The method of claim 16, wherein the optimizing comprises tuning a voltage of the delay-line interferometer so that a power difference between constructive and destructive ports is maximized.

19. The method of claim 16, wherein the optimizing comprises optimizing filter bandwidth and filter shape.

20. The method of claim 16, comprising measuring OSNR based on (i) measured power at a constructive port, (ii) measured power at a destructive port, (iii) a ratio between the measured power at the constructive port and the measured power at the destructive port, and (iv) a noise distribution ratio for a case when only ASE (Amplified Spontaneous Emission) noise is transmitted.
